(19) United States
(12) Patent Application Publication
(10) Pub. No.: US 2014/0298252 A1
(43) Pub. Date: Oct. 2, 2014

(54) IMAGE DISPLAY DEVICE AND CONTROL METHOD THEREOF

(71) Applicants: Yeojeong CHOI, Seoul (KR); Sanghyeun SON, Seoul (KR); Ilsoo YEOM, Seoul (KR); Eunji CHOI, Seoul (KR); Younsoo KIM, Seoul (KR)

(72) Inventors: Yeojeong CHOI, Seoul (KR); Sanghyeun SON, Seoul (KR); Ilsoo YEOM, Seoul (KR); Eunji CHOI, Seoul (KR); Younsoo KIM, Seoul (KR)

(21) Appl. No.: 14/170,780

(22) Filed: Feb. 3, 2014

(30) Foreign Application Priority Data
Apr. 2, 2013 (KR) 10-2013-0036042

(51) Int. Cl. G06F 3/0481

(52) U.S. Cl. CPC G06F 3/0481
USPC 715/788

(57) ABSTRACT

An image display device according to one embodiment of the present invention includes a touch sensing unit that senses a touch input, a display unit to which a window on which content is displayed is output, and a controller that, when the touch input for entering a division mode is sensed, outputs at least one or more imaginary division lines along which the display unit is divided, to a position that is according to a predetermined reference, considering the number of window regions that are output to the display unit before entering the division mode, and when the touch input that confirms the imaginary division line is sensed, divides the display unit into multiple divisional regions along the imaginary division line and outputs the items of content displayed on the window regions to the multiple divisional regions, respectively, according to a predetermined reference.

### RELATED APPLICATION

The present disclosure relates to subject matter contained in Korean Application No. 10-2013-0036042 filed on Apr. 2, 2013, which is herein expressly incorporated by reference in its entirety.

### TECHNICAL FIELD

The present invention relates to an image display device and more particularly to an image display device that is capable of dividing a screen and a method of controlling the image display device.

### BACKGROUND ART

An image display device includes a device for receiving and displaying broadcast, a device for recording and reproducing moving images, and a device for recording and reproducing audio. The image display device includes a television, a computer monitor, a projector, a tablet, etc.

As functions of the image display device become more diversified, the image display device can support more complicated functions such as capturing images or video, reproducing music or video files, playing games, receiving broadcast signals, and the like. By comprehensively and collectively implementing such functions, the image display device may be embodied in the form of a multimedia player. Recently, the image display device is implemented as a smart device (e.g., smart television). The image display device performs an internet function, and operates by interworking with a mobile terminal or a computer.

The image display device outputs various items of content at the same time. That is, the image display device has a multi-tasking function of outputting a moving image, a messenger message, and a document created by a word processor such as ARAE HAN-GEUL or MS Word.

Various method of dividing a screen of the image display device have been proposed to perform an effective multi-tasking function.

### DISCLOSURE OF THE INVENTION

Therefore, an object of the present invention is to improve user convenience in dividing a screen of an image display device.

To achieve these and other advantages and in accordance with the purpose of the present invention, as embodied and broadly described herein, there is provided an image display device includes a touch sensing unit that senses a touch input, a display unit to which a window on which content is displayed is output, and a controller that, when the touch sensing unit senses the touch input for entering a division mode, outputs at least one or more imaginary division lines along which the display unit is divided, to a position that is according to a predetermined reference, considering the number of window regions that are output to the display unit before entering the division mode, and when the touch input that confirms the imaginary division line is sensed, divides the display unit into multiple divisional regions along the imaginary division line and outputs the items of content displayed on the window regions to the multiple divisional regions, respectively, according to a predetermined reference.

In the image display device, the touch sensing unit may be realized as a touch panel arranged adjacent to the display unit or may be realized within an input device that can remotely communicate with the display unit.

In the image display device, the controller may move the imaginary division line according to the drag input sensed by the touch sensing unit.

In the image display device, the controller may output the imaginary division line along which the display unit is divided into the divisional regions, each of which is located in a position corresponding to a position on the display unit, to which the window region is output.

In the image display device, the controller may output the items of content that are displayed, to the multiple divisional regions, respectively, considering types of the items content that are displayed on the window regions and areas of the multiple divisional regions.

In the image display device, the controller may output the item of content that are displayed on the window regions, to the divisional regions, each of which is located in a position corresponding to a position on the display unit, to which the window region is output, respectively.

In the image display device, when the touch sensing unit senses the touch input for entering the division mode in a state where the window region to be output to the display unit is absent, the controller may display in advance the items of content that are to be output to the divisional regions that will be generated according to whether to confirm the imaginary division line, along with the imaginary division line along which the display unit is divided.

In the image display device, the controller may move the imaginary division line according to the sensed drag input, and may display in advance the items of content that are to be output to the divisional regions that will be generated according to whether to confirm the moved imaginary division line.

In the image display device, the controller may divide the display unit into the multiple divisional regions along the imaginary division line when the touch input that confirms the imaginary division line is sensed, and the controller may output the items of content that are displayed in advance, to the multiple divisional regions, respectively.

To achieve these and other advantages and in accordance with the purpose of the present invention, as embodied and broadly described herein, there is provided a method of controlling an image display device including a step (a) of enabling a touch sensing unit to sense a touch input for entering a division mode, a step (b) of outputting an imaginary division line along which the display unit is divided, to a position that is according to a predetermined reference, a step (c) of dividing the display unit into multiple divisional regions along the imaginary division line when the touch sensing unit senses a touch input that confirms the imaginary division line, a step (d) of repeating the step (b) and the step (c) considering the number of window regions on which items of content are displayed before entering the division mode; and a step (e) of outputting the items of content that are displayed on the window regions to the multiple division regions, respectively, when the imaginary division lines that are output are all confirmed.

In the method of controlling an image display device, the touch sensing unit may be realized as a touch panel arranged adjacent to the display unit or may be realized within an input device that can remotely communicate with the display unit.

In the method of controlling an image display device, the step (b) may include a step of moving the imaginary division line according to the drag input sensed by the touch sensing unit.

In the method of controlling an image display device, the step (b) may include a step of outputting the imaginary division line along which the display unit is divided into the divisional regions, each of which is located in a position corresponding to a position on the display unit, to which the window region is output.

In the method of controlling an image display device, the step (e) may include a step of outputting the items of content that are displayed, to the multiple divisional regions, respectively, considering types of the items of content that are displayed on the windows region and areas of the multiple divisional regions.

In the method of controlling an image display device, the step (e) may include a step of outputting the items of content that are displayed on the window regions to the divisional regions, each of which is located in a position corresponding to a position on the display unit, to which the window region is output.

In the method of controlling an image display device, when the touch sensing unit senses the touch input for entering the division mode in a state where the window region to be output to the display unit is absent, the step (b) may include a step of displaying in advance the items of content that are to be output to the divisional regions that will be generated according to whether to confirm the imaginary division line, along with the imaginary division line along which the display unit is divided.

In the method of controlling the image display device, the step (b) may include a step of moving the imaginary division line according to the sensed drag input, and displaying in advance the items of content that are to be output to the divisional regions that will be generated according to whether to confirm the moved imaginary division line.

In the method of controlling an image display device, the step (c) may include a step of dividing the display unit into the multiple divisional regions along the imaginary division line when the touch input that confirms the imaginary division line is sensed.

In the method of controlling an image display device, the step (e) may include a step of outputting the items of content that are displayed in advance, to the multiple divisional regions, respectively.

### BRIEF DESCRIPTION OF THE DRAWINGS

FIG. 1 is a block diagram illustrating an image display device according to the present invention and an external input device.

FIG. 2 is a block diagram illustrating in detail the external input device in FIG. 1.

FIG. 3 is a diagram illustrating a relationship between operation of the image display device according to the present invention and operation of the external input device.

FIGS. 4A and 4B are diagrams illustrating a touch sensing unit that is included in the image display device according to the present invention.

FIGS. 5A and 5B are diagrams illustrating an embodiment in which a screen is divided by the image display device according to the present invention.

FIG. 6 is a flow chart for describing a method of controlling the image display device according to one embodiment of the present invention.

FIG. 7 are diagrams, each illustrating an embodiment of a user interface in which an imaginary division line is output.

FIGS. 8A to 8D are diagrams illustrating an embodiment of a user interface in which the imaginary division line is moved.

FIGS. 9A to 9D are diagrams, each illustrating an embodiment of a process in which the screen is divided by the image display device according to the present invention.

FIG. 10 is a diagram illustrating an embodiment in which content is output to each divisional region.

FIGS. 11A to 11E are diagrams illustrating an embodiment of a process in which in a state where the window region is not output, the screen is divided by the image display device the according to the present invention.

FIGS. 12A to 12D are diagrams illustrating the image display device according to the present invention in a case where the touch sensing unit is realized as the touch screen.

### MODES FOR CARRYING OUT THE PREFERRED EMBODIMENTS

Hereinafter, preferred embodiments of the present invention will be explained in more detail with reference to the attached drawings. The same or similar components of one embodiment as or to those of another embodiment will be provided with the same or similar reference numerals, and their detailed explanations will be omitted.

An image display device according to the present invention includes a device for receiving and displaying broadcast, a device for recording and reproducing moving images, and a device for recording and reproducing audio. Hereinafter, the image display device will be explained by taking a television as an example

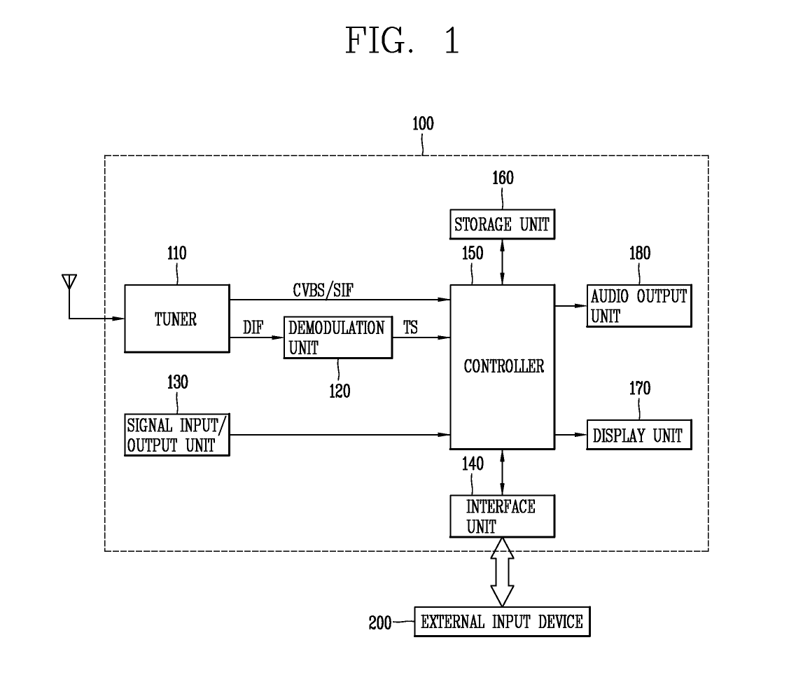

FIG. 1 is a block diagram illustrating an image display device 100 of the present invention, and an external input device 200. The image display device 100 includes a tuner 110, a demodulation unit 120, a signal input and output unit 130, an interface unit 140, a controller 150, a storage unit 160, a display unit 170 and an audio output unit 180. The external input device 200 is an apparatus that is separated from the image display device 100, but may be included as one constituent element of the image display device 100.

Referring to FIG. 1, the tuner 110 selects a broadcast signal corresponding to a channel selected by the user, from radio frequency (RF) broadcast signals, and converts the selected broadcast signal into an intermediate frequency signal or a baseband video and voice signal. For example, if the RF broadcast signal is a digital broadcast signal, the tuner 110 converts the RF broadcast signal into a digital IF signal (DIF). In contrast, if the RF broadcast signal is an analog broadcast signal, the tuner 110 converts the RF broadcast signal into a baseband video and voice signal (CVBS/SIF). In this manner, the tuner 110 is a hybrid tuner that processes the digital broadcast signal and the analog broadcast signal.

A digital IF signal (DIF), output from the tuner 110, is input into the demodulation unit 120, and the analog baseband video and voice signal (CVBS/SIF), output from the tuner 110, is input into the controller 150. The tuner 120 receives a single carrier RF broadcast signal according to advanced television systems committee (ATSC) standards or a multiple-carrier RF broadcast signal according to digital video broadcasting (DVB) standards.

Although one tuner 110 is illustrated in the drawings, the image display device 100 is not limited to the one tuner and may include the multiple tuners, for example, first and second tuners. In this case, the first tuner receives a first RF broadcast signal corresponding to the broadcast channel selected by the user, and the second tuner receives a second RF broadcast signal corresponding to the already-stored broadcast channel sequentially and periodically. The second tuner converts the RF broadcast signal into the digital IF signal (DIF), or the analog baseband video and voice signal (CVBS/SIF), in the same manner as the first tuner.

The demodulation unit 120 receives the digital IF signal (DIF) that results from the conversion and performs a demodulation operation. For instance, if the digital IF signal (DIF), output from the tuner 110, is in the ATSC format, the demodulation unit 120 performs 8-vestigial side band (8-VSB) modulation. At this time, the demodulation unit 120 may perform channel decoding, such as Trellis decoding, de-interleaving, and Reed-Solomon decoding. To do this, the demodulation unit 120 may include a Trellis decoder, a deinterleaver, a Reed-Solomon decoder, and the like.

When the digital IF signal (DIF), output from the tuner 110, is in the DVB format, the demodulation unit 120 performs coded orthogonal frequency division modulation (COFDMA) modulation. At this time, the demodulation unit 120 may perform channel decoding, such as convolution decoding, the de-interleaving, and the Reed-Solomon decoding. To do this, the demodulation unit 120 may include a convolution decoder, the deinterleaver, and the Reed-Solomon decoder.

The signal input and output unit 130 is connected to an external apparatus for signal input and signal output operations. To do this, the signal input and output unit 130 may include an A/V input and output unit, and a wireless communication unit.

The NV input/output unit may include an Ethernet port, a USB port, a composite video banking sync (CVBS) port, a component port, an S-video port (analog), a digital visual interface (DVI) port, a high definition multimedia interface (HDMI) port, a mobile high-definition link (MHL) port, an RGB port, a D-SUB port, an IEEE 1394 port, an SPDIF port, a liquid HD port, and the like. A digital signal, input through such ports, is transferred to the controller 150. At this time, an analog signal, input through the CVBS port and the S-VIDEO port, is converted into the digital signal by an analog-to-digital converter (not illustrated) and is transferred to the controller 150.

The wireless communication unit performs wireless connection to the Internet. The wireless communication unit performs the wireless connection to the Internet by using wireless communication technologies, such as wireless LAN (WLAN) (Wi-Fi), wireless broadband (Wibro), world interoperability for microwave access (Wimax), and high speed downlink packet access (HSPPA). In addition, the wireless communication unit can perform short-range communication with a different electronic apparatus. For example, the wireless communication unit performs the short-range communication by using short-range communication technologies, such as Bluetooth, radio frequency identification (RFID), infrared light communication (IrDA, infrared Data Association), ultra wideband (UWB), and ZigBee.

The signal input and output unit 130 may transmit, to the controller 150, image signals, voice signal and data signal provided from an external device, such as a digital versatile disk (DVD) player, a Blu-ray disk player, a game apparatus, a camcorder, a notebook computer, a portable device and a smart phone. Further, the signal input and output unit 130 may transmit, to the controller 150, image signals, voice signals and data signals of various media files that are stored in an external storage device such as a memory device and a hard disk drive. Further, the signal input and output unit 130 may output, to other external device, image signals, voice signals and data signals processed by the controller 150.

More specifically, the signal input and output unit 130 is connected to a set-top box, for example, a set-top box for Internet Protocol TV (IPTV), through at least one of the ports described above, and performs signal input and output operations. For instance, the signal input and output unit 130 transfers image signals, voice signals, and data signals, which are processed by the set-up box for IPTV in such a manner the image signals, the voice signals, and the data signals are available for bidirectional communication, to the controller 150, and transfers the signals processed by the controller 150 back to the set-up box for IPTV. The IPTV may include ADSL-TV, VDSL-TV, and FTTH-TV that are different in transmission network.

Digital signals output from the demodulation unit 120 and the signal input and output unit 130 may include a stream signal (TS). The stream signal may result from multiplexing a video signal, a voice signal and a data signal. For example, the stream signal TS is an MPEG-2 transport stream (TS) that results from multiplexing an MPEG-2 standard video signal, a Dolby AC-3 standard voice signal, and the like. Here, MPEG-2 TS may include a 4 byte header and a 184 byte payload.

The interface unit 140 may receive, from the external input device 200, an input signal for power source control, channel selection, screen setting and the like. Alternatively, the interface unit 140 may transmit a signal processed by the controller 150 to the external input device 200. The interface unit 140 and the external input device 200 may be connected to each other, by a cable or wirelessly.

The interface unit 140 may be provided with a sensor, and the sensor is configured to sense the input signal from a remote controller.

A network interface unit (not shown) provides an interface for connecting the image display device 100 with a wire/wireless network including an Internet network. The network interface unit may be provided with an Ethernet port, etc. for connection with a wired network. For connection with a wireless network, the network interface unit may utilize a wireless Internet technique, such as a wireless local area network (WLAN), Wi-Fi, wireless broadband (WiBro), world interoperability for microwave access (WiMAX) and high speed downlink packet access (HSDPA).

The network interface unit (not shown) may access a prescribed web page through a network. That is, the network interface unit may access a prescribed web page through a network, thereby transmitting or receiving data to/from a corresponding server. Besides, the network interface unit may receive content or data provided from a content provider or a network operator. That is, the network interface unit may receive content such as movies, an advertisement, a game, VOD, and broadcast signals, and various items of information relating to the content, which are provided a content service provider or a network administrator. The network interface unit may receive firmware update information and update files provided by a network administrator, and transmit data to a content provider or a network operator.

The network interface unit (not shown) may receive an application selected by a user among applications that are placed in a public domain.

The controller 150 may control the entire operation of the image display device 100. More specifically, the controller may control the tuner 110 to tune an RF broadcast signal corresponding to a channel selected by a user or a pre-stored channel. Although not illustrated in the drawings, the controller 150 may include an inverse multiplexing unit, an image processing unit, a voice processing unit, a data processing unit, an on-screen-display (OSD) generation unit, etc. Besides, the controller 150 may include a CPU, peripheral devices, etc. by hardware.

The controller 150 may output image signals, voice signals and data signals by inversely-multiplexing a stream signal (TS), e.g., MPEG-2 TS.

The controller 150 may perform image processing, e.g., decoding, on an inversely-multiplexed image signal. More specifically, the controller 150 may decode an MPEG-2 standard-encoded image signal by using an MPEG-2 decoder, and may decode an H.264 standard-encoded image signal according to digital multimedia broadcasting (DMB) standard or digital video broadcast-handheld (DVB-H) standards by using an H.264 decoder. In addition, the controller 150 may perform imaging processing in such a manner that brightness, tint and color of an image signal are adjusted. In this manner, the image signal, which is image-processed by the controller 150, may be transferred to the display unit 170 or transferred to an external output apparatus (not illustrated) through an external output port.

The controller 150 may perform, voice processing, for example, decoding, on an inversely multiplexed voice signal. More specifically, the controller 150 may decode an MPEG-2 standard-encoded voice signal by using an MPEG-2 decoder, decode an MPEG 4 bit sliced arithmetic coding (BSAC) standard-encoded voice signal according to the DMB standards by using an MPEG 4 decoder, and decode an MPEG 2 advanced audio coded (AAC) standard-encoded voice signal according to satellite DMB standards or the digital video broadcast-handheld (DVB-H) standards by using an AAC decoder. In addition, the controller 150 may perform base processing, treble processing, and sound volume processing. The voice signal that is processed by the controller 150 in this manner may be transferred to the audio output unit 180, for example, a speaker, or may be transferred to an external out device.

The controller 150 may perform signal processing on an analog baseband image/voice (CVBS/SIF). For example, the analog baseband image and voice signal (CVBS/SIF), input into the controller 150, is the analog baseband image and voice signal, output from the tuner 110 or the signal input and output unit 130. The controller 150 performs the control in such a manner that the analog baseband image and voice signal (CVBS/SIF) that is input is processed, the signal-processed image signal is displayed on the display unit 170, and the signal-processed voice signal is output to the audio output unit 180.

The controller 150 may perform data processing, for example, decoding, on an inversely multiplexed data signal. The data signal here includes electronic program guide (EPG) information including broadcast information, such as a broadcasting-starting time and a broadcasting-ending time of a broadcast program that is broadcast over each channel. The EPG information includes, for example, ATSC-program and system information protocol (ATSC-PSIP) information in the case of ATSC standards and includes DVB-service information (DVB-SI) information in the case of DVB. The ATSC-PSIP information or the DVB-SI information here is included in a header (4 byte) of the MPEG-2 stream signal TS.

The controller 150 may perform a control for processing OSD. More specifically, the controller 150 may generate an OSD signal for displaying various types of information in the form of a graphic or a text, based on at least one of image signals and data signal or based on an input signal received from the external input device 200. The OSD signal may include various types of data of the image display device 100, such as a user interface screen, a menu screen, widgets and icons.

The storage unit 160 may store a program for the signal processing and the control by the controller 150, and store signal-processed image signals, voice signals and data signals. The storage unit 160 may include at least one of the following storage media: a flash memory, a hard disk, a multimedia card micro type), a card type memory (for example, an SD or XD memory), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The display unit 17 may generate a driving signal by converting image signals, data signals, OSD signals, etc. processed by the controller 150, into an RGB signal. Through this process, the resulting image is output to the display unit 170. The display unit 170 may be implemented in various forms as follows: a plasma display panel (PDP), a liquid crystal display (LCD), a thin film transistor-liquid crystal display (TFT-LCD), an organic light emitting diode (OLED), a flexible display, a 3D display, and an e-ink display. Alternatively, the display unit 170 may be implemented as a touch screen serving as an input device.

The audio output unit 180 outputs a voice signal processed by the controller 150, for example, a stereo signal or a 5.1 channel signal. The audio output unit 180 may be implemented as various types of speakers.

The image display device 100 may further include an imaging unit (not illustrated) for photographing a user. The imaging unit may be implemented as one camera, but may be implemented as multiple cameras. Image information captured by the imaging unit (not shown) is input into the controller 150.

The image display device 100 may further include a sensing unit (not shown) having at least one of a touch sensor, a voice sensor, a location sensor and an operation sensor, in order to detect a user's gesture. A signal detected by the sensing unit (not shown) may be transferred to the controller 150 through the inter face unit 140.

The controller 150 may detect a user's gesture by combining images captured by an imaging unit (not shown), or signals detected by a sensing unit (not shown).

A power supply unit (not illustrated) supplies electric power to the image display device 100 across the board. Specifically, the power supply unit may supply electric power the controller 150 that is implemented in the form of a system-on chip (SOC), the display unit 170 for displaying images, and the audio output unit 180 for outputting audio.

To do this, the power supply unit (not illustrated) may include a converter (not illustrated) that converts DC power into AC power. For example, if the display unit 170 is implemented as a liquid crystal panel including multiple backlight lamps, the power supply unit further includes an inverter (not illustrated) in which PWM operation is possible for brightness variability and dimming drive.

The external input device 200 is connected to the interface unit 140 by a cable or wirelessly and transmits an input signal that is generated according to a user input, to the interface unit 140. The external input device 200 may include a remote controller, a mouse, a keyboard, and the like. The remote controller may transmit an input signal to the interface unit 140 by using Bluetooth communication, RF communication, IR communication, ultra wideband (UWB) communication, ZigBee communication, or the like. If the external input device 200 is implemented, specifically, as a spatial remote controller, the external input device 200 generates an input signal by detecting a movement of the main body.

If the image display device 100 is implemented as a fixed type digital broadcast receiver, the image display device 100 is implemented in such a manner as to receive at least one of the following broadcast types: digital broadcast to apply an ATSC type (8-VSB type), digital broadcast to apply a ground wave DVB-T type (COFDM type), and digital broadcast to apply an ISDB-T type (BST-OFDM type). If the image display device 100 is implemented as a mobile digital broadcast receiver, the image display device 100 is implemented in such a manner as to receive at least one of the following broadcast types: digital broadcast to apply a ground wave DMB type, digital broadcast to apply a satellite DMB type, digital broadcast to apply an ATSC-M/H type, digital broadcast to apply a digital video broadcast-handheld (DVB-H) type (COFDM type), and digital broadcast to apply a media forward link-only type. The image display device 100 may be implemented as a digital broadcast receiver for cable communication, satellite communication or IPTV.

The image display device may be applied to a mobile terminal. The mobile terminal may include cellular phones, smart phones, laptop computers, digital broadcasting terminals, personal digital assistants (PDAs), portable multimedia players (PMPs), navigators, slate PCs, tablet PC, ultra books and the like.

In a case where the image display device is used as a mobile terminal, a wireless communication unit may be further included.

The wireless communication unit may include one or more components to authorize wireless communication between the mobile terminal 100 and a wireless communication unit system or a network in which the mobile terminal 100 is located. For example, the wireless communication unit may include at least one of a broadcast receiving module, a mobile communication module, a wireless Internet module, a short range communication module and a location information module.

The broadcast receiving module receives broadcast signals and/or broadcast associated information from an external broadcast management server (or other network entity) via a broadcast channel.

The broadcast channel may include a satellite channel and a terrestrial channel. The broadcast managing entity may indicate a server which generates and transmits a broadcast signal and/or broadcast associated information or a server which receives a pre-generated broadcast signal and/or broadcast associated information and sends them to the mobile terminal. The broadcast signal may be implemented as a TV broadcast signal, a radio broadcast signal, and a data broadcast signal, among others. The broadcast signal may further include a data broadcast signal combined with a TV or radio broadcast signal.

Examples of broadcast associated information may include information associated with a broadcast channel, a broadcast program, a broadcast service provider, and the like. The broadcast associated information may be provided via a mobile communication network, and received by the mobile communication module 112.

The broadcast associated information may be implemented in various formats. For instance, broadcast associated information may include Electronic Program Guide (EPG) of Digital Multimedia Broadcasting (DMB), Electronic Service Guide (ESG) of Digital Video Broadcast-Handheld (DVB-H), and the like.

The broadcast receiving module may be configured to receive digital broadcast signals transmitted from various types of broadcast systems. Such broadcast systems may include Digital Multimedia Broadcasting-Terrestrial (DMB-T), Digital Multimedia Broadcasting-Satellite (DMB-S), Media Forward Link Only (MediaFLO), Digital Video Broadcast-Handheld (DVB-H), Integrated Services Digital Broadcast-Terrestrial (ISDB-T) and the like. The broadcast receiving module may be configured to be suitable for every broadcast system transmitting broadcast signals as well as the digital broadcasting systems.

Broadcast signals and/or broadcast associated information received via the broadcast receiving module may be stored in a suitable device, such as a memory.

The mobile communication module 112 transmits/receives wireless signals to/from at least one of network entities (e.g., base station, an external mobile terminal, a server, etc.) on a mobile communication network. Here, the wireless signals may include audio call signal, video (telephony) call signal, or various formats of data according to transmission/reception of text/multimedia messages.

The mobile communication module may implement a video call mode and a voice call mode. The video call mode indicates a state of calling with watching a callee's image. The voice call mode indicates a state of calling without watching the callee's image. The mobile communication module may transmit and receive at least one of voice and image in order to implement the video call mode and the voice call mode.

The wireless Internet module supports wireless Internet access for the mobile terminal. This module may be internally or externally coupled to the mobile terminal 100. Examples of such wireless Internet access may include Wireless LAN (WLAN) (Wi-Fi), Wireless Broadband (Wibro), Worldwide Interoperability for Microwave Access (Wimax), High Speed Downlink Packet Access (HSDPA) and the like.

The short-range communication module denotes a module for short-range communications. Suitable technologies for implementing this module may include BLUETOOTH™, Radio Frequency IDentification (RFID), Infrared Data Association (IrDA), Ultra-WideBand (UWB), ZigBee™, Near Field Communication (NFC), WiFi direct, and the like.

The location information module denotes a module for detecting or calculating a position of a mobile terminal. An example of the location information module may include a Global Position System (GPS) module and a wireless fidelity (WiFi) module.

If the display unit and a touch sensitive sensor (referred to as a touch sensor) have a layered structure therebetween (referred to as a ‘touch screen’), the display unit may be used as an input device as well as an output device. The touch sensor may be implemented as a touch film, a touch sheet, a touchpad, and the like.

The touch sensor may be configured to convert changes of a pressure applied to a specific part of the display unit, or a capacitance occurring from a specific part of the display unit, into electric input signals. Also, the touch sensor may be configured to sense not only a touched position and a touched area, but also touch pressure. Here, a touch object is an object to apply a touch input onto the touch sensor. Examples of the touch object may include a finger, a touch pen, a stylus pen, a pointer or the like.

When touch inputs are sensed by the touch sensors, corresponding signals are transmitted to a touch controller. The touch controller processes the received signals, and then transmits corresponding data to the controller. Accordingly, the controller may sense which region of the display unit has been touched.

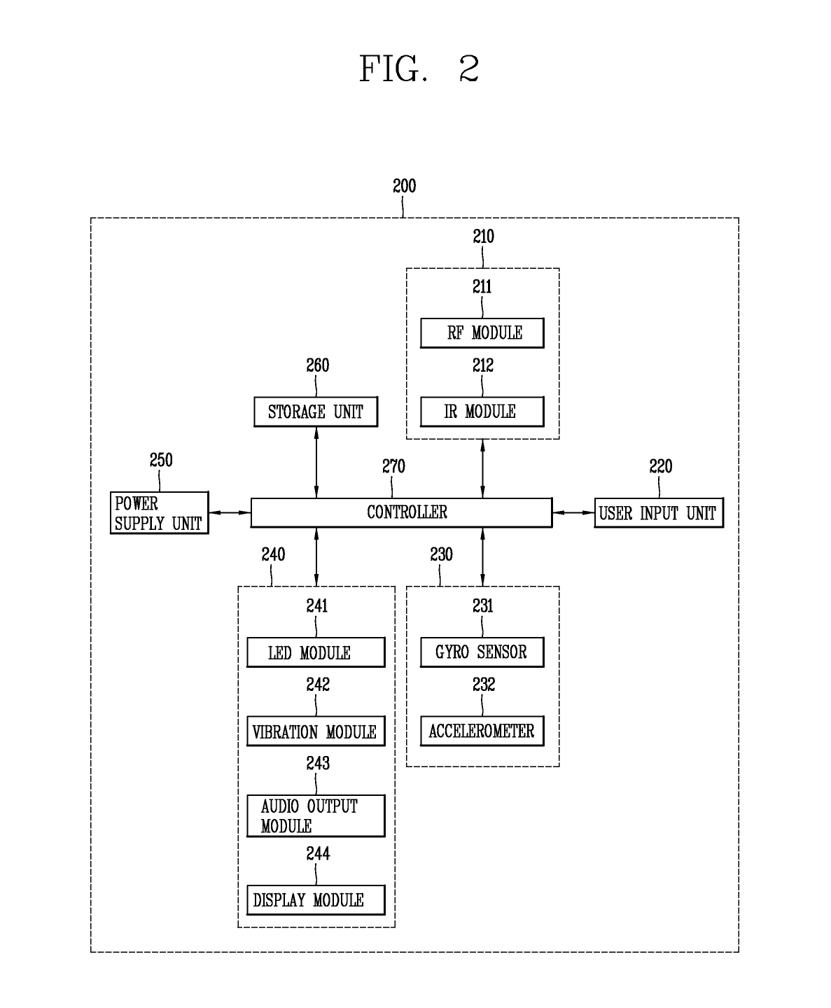

FIG. 2 is a block diagram illustrating in detail the external input device 200 in FIG. 1. The external input device 200 includes a wireless communication unit 210, a user input unit 220, a sensing unit 230, an output unit 240, a power supply unit 250, a storage unit 260 and a controller 270.

Referring to FIG. 2, the wireless communication unit 210 transmits a signal to the image display device 100, or receives a signal from the image display device 100. To this end, the wireless communication unit 210 may be provided with an RF module 211 and an IR module 212. The RF module 211 is connected to the interface unit 140 of the image display device 100 according to an RF communication standard, thereby transmitting and receiving signals. The IR module 212 transmits or receives signals to/from the interface unit 140 of the image display device 100, according to an IR communication standard.

The user input unit 220 may be provided with a key pad, key buttons, a scroll key, a jog key, etc. as an input means. A user may input a command related to the image display device 100, by manipulating the user input unit 220. The command may be input through a user's operation to push a hard key button of the user input unit 200.

The sensing unit 230 may be provided with a gyro sensor 231 and an acceleration sensor 232. The gyro sensor 231 may sense a spatial movement of the external input device 200 in an X-axis, a Y-axis and a Z-axis. The acceleration sensor 232 may sense a moving speed, etc. of the external input device 200.

The output unit 240 outputs information according to manipulation of the user input unit 230, or information corresponding to a transmit signal of the image display device 100. Under such configuration, a user can recognize a manipulated state of the user input unit 230, or a control state of the image display device 100. For instance, the output unit 240 may be provided with an LED module 241, a vibration module 242, a sound output module 243 and a display module 244 each performing a corresponding function, in response to signal transmission/reception through manipulation of the user input unit 230 or through the wireless communication unit 210.

The power supply unit 250 supplies power to various types of electronic devices of the external input device 200. If the external input device 200 is not moved for a prescribed time, the power supply unit 250 stops supplying power to prevent waste of power. If a prescribed key of the external input device 200 is manipulated, the power supply unit 250 may resume power supply.

The storage unit 260 may store therein information on various types of programs related to control or operation of the external input device 200, application information, frequency band information, etc. The controller 270 performs an operation to control the external input device 200.

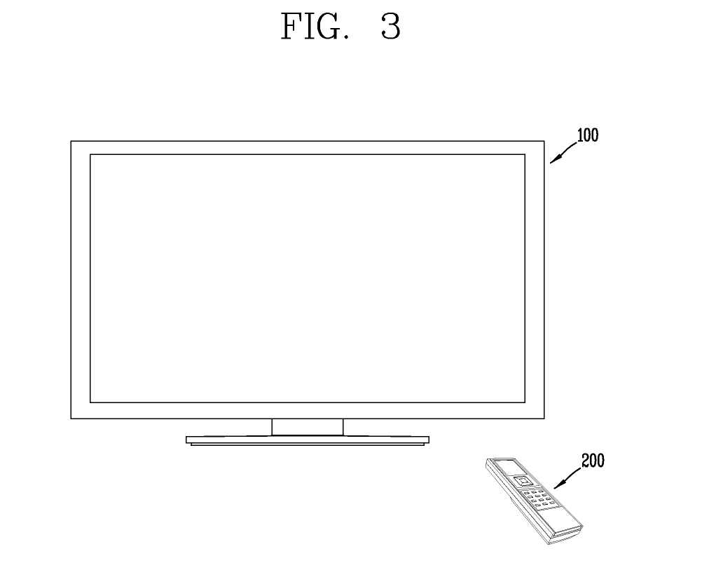

FIG. 3 is a diagram illustrating a relationship between operation of the image display device 100 according to the present invention and operation of the external input device 200. The image display device 100 is implemented as a TV receiver, and the external input device 200 is implemented as a remote controller.

Referring to FIG. 3, the external input device 200 may transmit or receive signals to/from the image display device 100 according to an RF communication standard. A control menu may be displayed on a screen of the image display device 100 according to a control signal of the external input device 200. The external input device 200 may be provided with a plurality of buttons, and may generate an external input signal according to a user's operation to manipulate buttons.

The image display device 100 according to the present invention includes a touch sensing unit, the display unit 170, and the controller 150.

At this point, the touch sensing unit is realized as a touch panel that is arranged adjacent to the display unit 170 or is realized within an input device that can remotely communicate with the display unit 170.

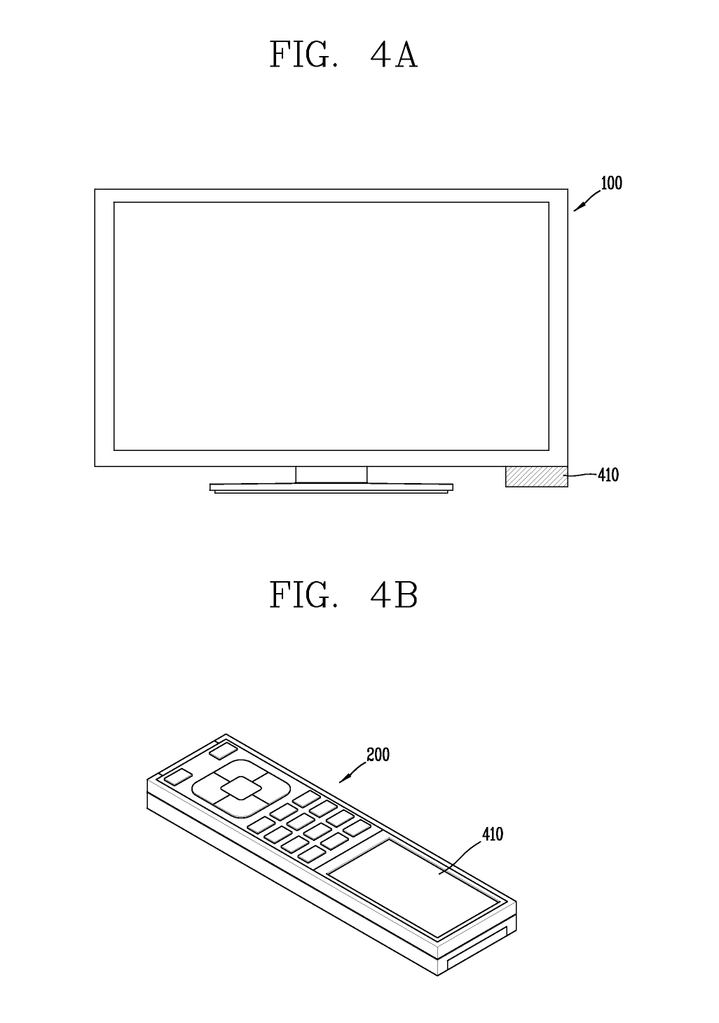

FIGS. 4A and 4B are diagrams, each illustrating an embodiment of the touch sensing unit that is included in the image display device 100 according to the present invention.

Referring to FIG. 4A, the touch sensing unit is realized as a touch panel 410 that is arranged adjacent to a bezel of the display unit 170.

At this point, the touch panel 410 is arranged in the arbitrary position that is adjacent to the bezel. For example, the touch panel 410 is arranged on the side of the bezel, which faces the inside of the display unit 170 or on the opposite side of the bezel, which faces the outside of the display unit 170. Alternatively, the touch panel 410 may be arranged in the lower or upper right side, the lower or upper left side of the bezel.

According to another embodiment, the touch panel 410 may be arranged over the entire region of the bezel or in one region of the bezel.

This arrangement of the touch panel 410 is described in detail below. If the touch sensing unit is arranged adjacent to the display unit 170 in this manner, the display unit 170 is realized a monitor for a computer or a monitor for a notebook computer, but is not limited to these.

In addition, the display unit 170 is realized as a touch screen that can sense the touch input independently of the touch sensing unit, but is not limited to this configuration.

Referring to FIG. 4B, the touch sensing unit is realized within the input device that can remotely communicate with the display unit 170.

At this point, the input device is realized as a separate device dedicated to the touch input or as a device for transmitting a different communication signal along with a touch input signal.

For example, the touch sensing unit is realized as the touch panel 410 that is arranged in a remote controller that can remotely communicate with a TV monitor 170. At this point, the image display device 100 according to the present invention includes the touch panel 410 arranged within the external input device 200, as a constituent element.

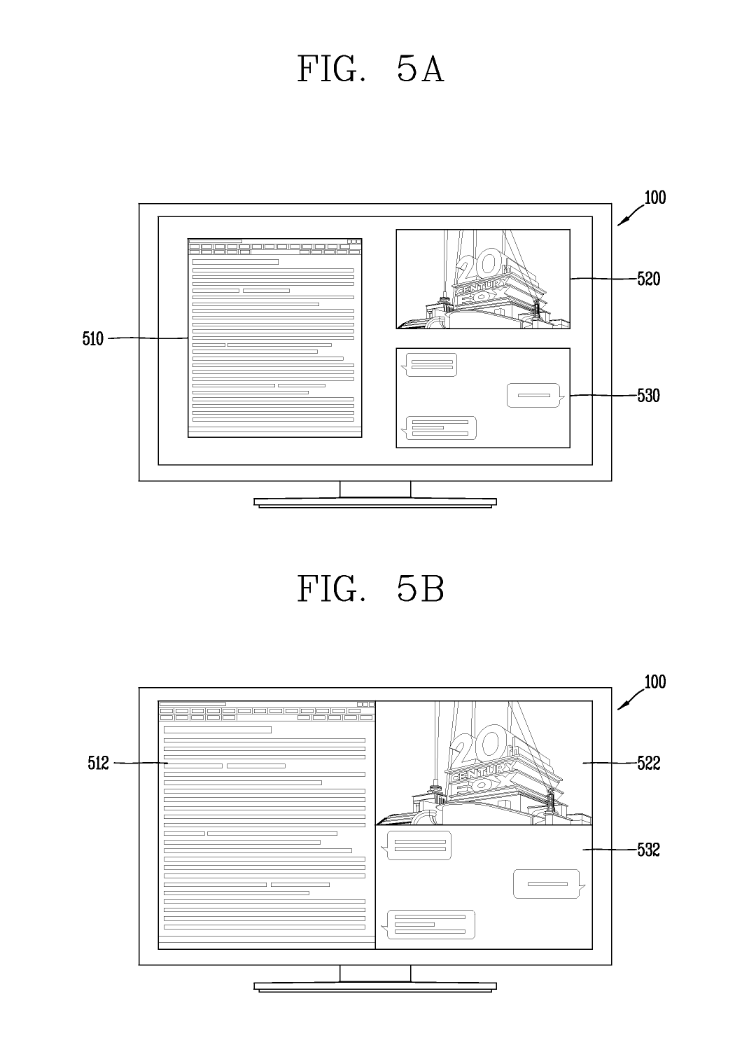

FIGS. 5A and 5B are diagrams, each illustrating an embodiment in which a screen 170 is divided by the image display device 100 according to the present invention.

FIG. 5A illustrates the embodiment in which before the touch sensing unit 410 senses the touch input for entering a division mode, multiple window regions on which multiple items of content are displayed are output to the screen.

The division mode is for dividing the screen 170 into multiple divisional regions. When the touch sensing unit 410 senses the touch input described above, such as a long touch input or a double tap input, the division mode is entered. As an example of this, FIG. 5A illustrates what the screen 170 looks like before sensing such a touch input.

At this point, content means various items of information that can be output to the screen 170. For example, the content includes a moving image, a messenger message, information retrieved by a web browser, and a document created by a word processor such as ARAE HAN-GEUL or MS Word.

The window region means an individual region on the screen 170, on which such content is displayed. For example, the window region includes a rectangular region, a portion of the screen 170, on which the web browser or a moving-image media player is executed.

It is seen from FIG. 5A that a first region 510, a second window region 520, and a third window region 530 are accordingly output to the screen 170. The document is created on the first window region 510. The moving-image player is executed on the second window 520, and the messenger is executed on the third window region 530.

It is seen from FIG. 5B that the screen 170 is divided by the image display device 100 according to the present invention. It is seen from FIG. 5B that the items of content displayed on the window regions are output to the multiple divisional regions, respectively.

Specifically, the document being created on the first window region 510 is output to a first divisional region 512, the moving image being reproduced on the second window region 520 is output to a second divisional region 522, and the messenger message being created on the third window region 530 is output to a third divisional region 532.

Consequently, it is seen that the content displayed on the window region is output to the divisional region that is located in a position corresponding to a position to which the window region is output.

A process is described in detail below, in which the screen 170 is divided in this manner by the image display device 100 according to the present invention.

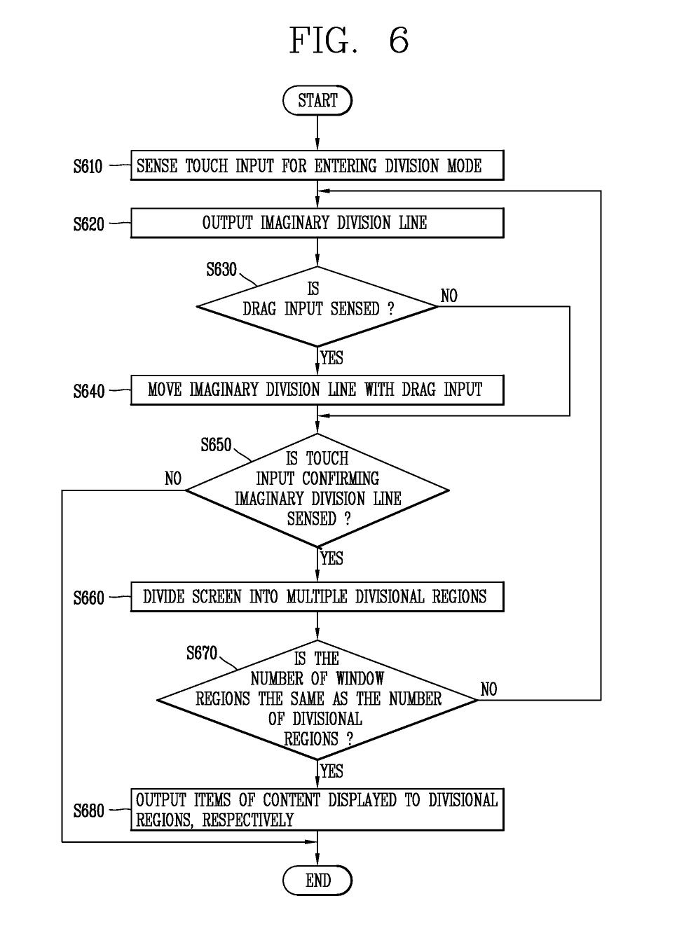

FIG. 6 is a flow chart for describing a method of controlling the image display device 100 according to one embodiment of the present invention.

Referring to FIG. 6, first, Step S610 proceeds in which the touch input for entering the division mode is sensed by the touch sensing unit.

As described above, when the long touch input or the double tap input is sensed by the touch sensing unit, the division mode is entered.

Subsequently, Step S630 proceeds in which an imaginary division line along which the screen 170 is divided is output to a position that is according to a predetermined reference. A position to which the imaginary division line is initially output is described in detail below.

Next, Step S630 proceeds in which it is determined whether the touch sensing unit senses a drag input.

When it is determined that the drag input is sensed, Step S640 proceeds in which the imaginary division line that is earlier output to the screen 170 is moved.

That is, the user changes the initial position to which the imaginary division line is output, by applying the drag input to the touch sensing unit. This change is described in detail below.

After the imaginary division line is moved according to the drag input (S640), or when the drag input is not sensed in S630, Step 650 proceeds in which it is determined whether the touch sensing unit that confirms the touch input senses the touch input.

According to a specific embodiment, the imaginary division line is confirmed by moving the imaginary division line with the drag input and then stopping the touch input.

According to another embodiment, the initially-output imaginary division line is confirmed by applying the long touch input, a short touch input, a short touch input at a brief interval of time and others.

Subsequently, when the touch input, as described above, which confirms the imaginary division line, is sensed, Step S660 proceeds in which the screen 170 is divided into the multiple divisional regions, along the imaginary division line.

However, when the touch input that confirms the imaginary division line is not sensed, the process of entering the division mode is ended. Subsequently, after Step S660 in which the screen 170 is divided, Step S670 proceeds in which it is determined that the number of the window regions that are output to the screen 170 before entering the division mode is the same as the number of the current divisional regions.

Specifically, it is determined that before entering the division mode, one window region is output to the screen 170 or the number of the window regions that are output to the screen 170 is the same as the number of the current divisional region (S670), Step S680 proceeds in which the items of content displayed on the window regions are output to multiple divisional regions, respectively, according to a predetermined reference. The reference for outputting the content at this point is described in detail below.

In contrast, when it is determined that the number of the window regions that are output to the screen 170 before entering the division mode is not the same as the number of the current divisional region, Step S620 again proceeds in which the imaginary division line is output.

That is, when one imaginary division line is output at the time of the entering of the division mode and the imaginary division line that is output is confirmed, the imaginary division line is again output considering the number of the window regions that are output to the screen 170 before entering the division mode. This outputting of the imaginary division line is described in detail below.

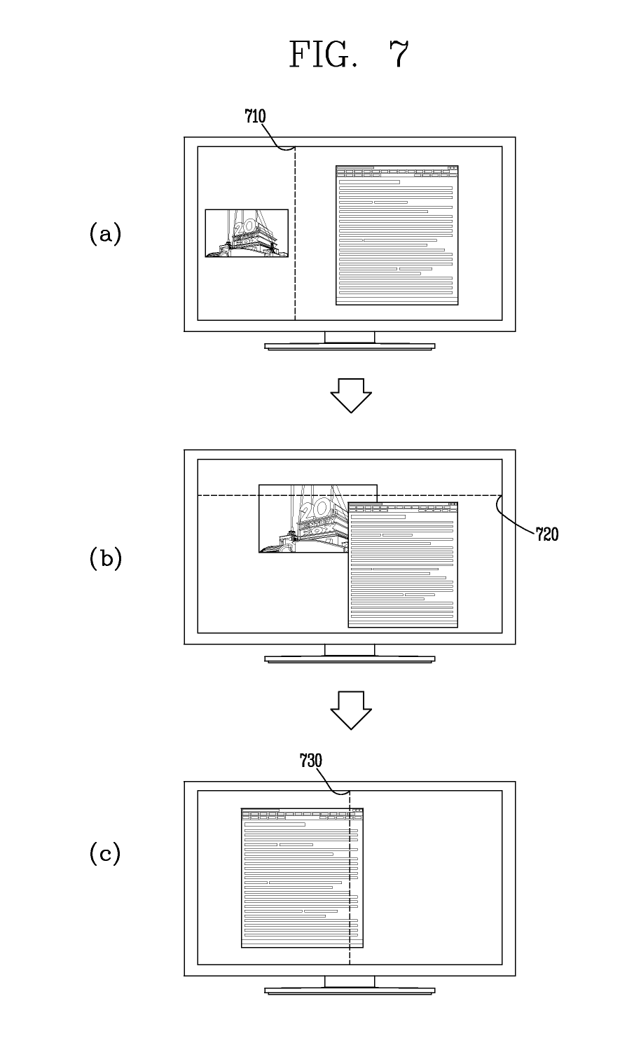

FIG. 7 are diagrams, each illustrating an embodiment of a user interface in which the imaginary division line is output.

Referring to FIG. 7(a), the first and second window regions are output before entering the division mode. When the division mode is entered at this point, the imaginary division line is output to a portion 710 corresponding to a border line between the first and second window regions.

Referring to FIG. 7(b), the second window region is output in such a manner as to cover and overlap one portion of the first window region. When the division mode is entered at this point, the imaginary division line is output to a corresponding upper edge portion 720 of the second window region that is output and is broader in scope than the first window region.

In this manner, the imaginary division line is output in such a manner that the divisional region that is located in the position that corresponds to the position on the screen 170, to which the window region is output, is generated.

Referring to FIG. 7(c), the first and second window regions are output in such a manner as to overlap each other. When the division mode is entered at this point, the imaginary division line is output to a specific position 730 on the screen 170, which is predetermined.

For example, the imaginary division line along which the screen 170 is divided longitudinally or transversely is output to the middle of the screen 170.

According to another embodiment, the imaginary division lines are sequentially output to the predetermined position regardless of the positions to which the multiple window regions are output.

The user adjusts the position of the imaginary division line that is output in this manner, with the drag input.

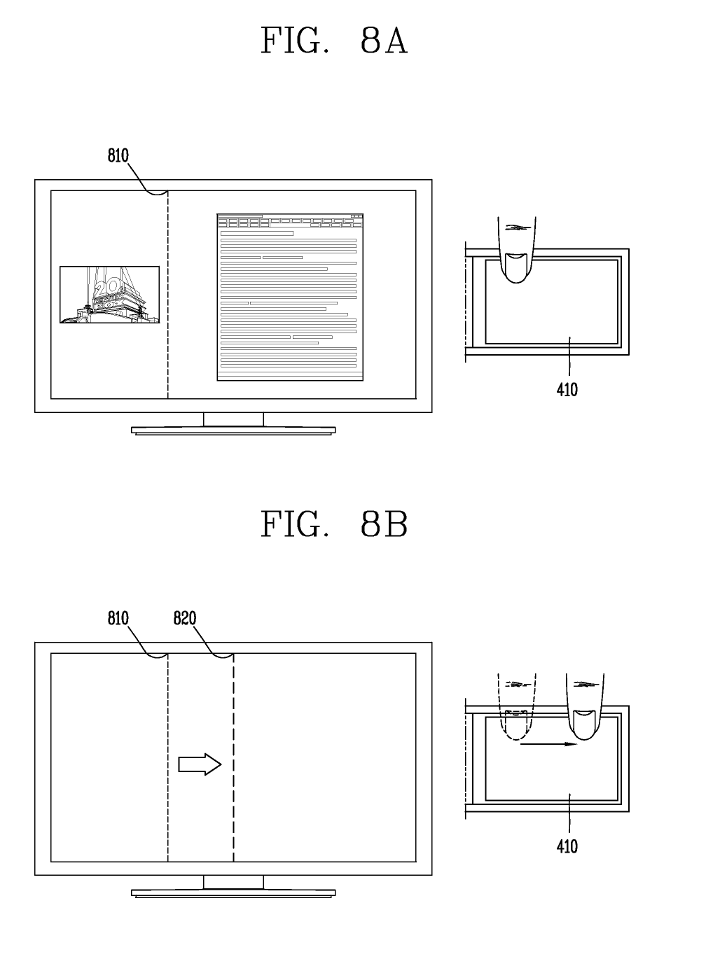

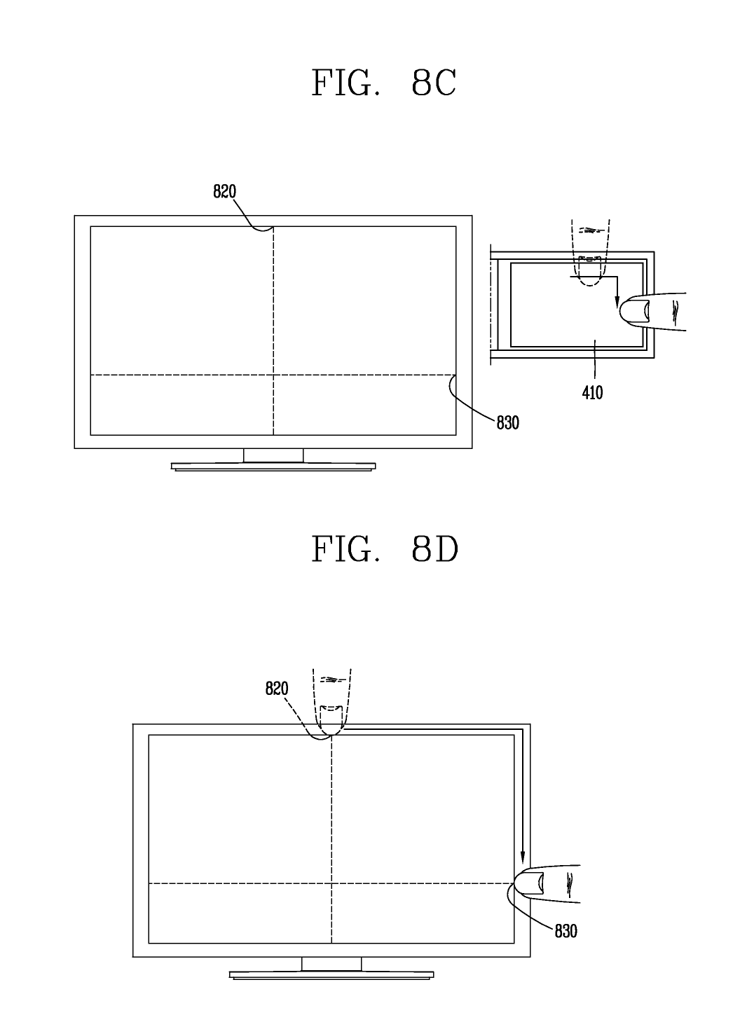

FIGS. 8A to 8D are diagrams illustrating an embodiment of a user interface in which the imaginary division line is moved.

Referring to FIG. 8A, the first and second window regions are output to the screen 170 before entering the division mode. When the touch sensing unit senses the long touch input for entering division mode, the imaginary division line is output to a portion 810 corresponding to the border line between the first and second window regions.

Referring to FIG. 8B, when the touch sensing unit senses the drag input in which the touch is dragged rightward from a long touch point, an imaginary division line 810 that is output, as illustrated in FIG. 8A, is horizontally moved rightward in proportion to a distance that the touch is dragged.

Referring to FIG. 8C, the touch sensing unit senses the drag input in which a dragging direction is changed at the edge of the touch sensing unit. That is, the rightward drag input and the downward drag input are sensed.

Accordingly, an imaginary division line 820, output as illustrated in FIG. 8B is moved rightward in parallel and then passes a fixed point on the screen 170 and clockwise rotates 90 degrees. Then, the imaginary division line 820 is moved downward in parallel in proportion to the distance that the touch is dragged, resulting in an imaginary division line 830. That is, the direction in which the screen 170 is divided is changed from a longitudinal direction to a transverse direction according to a directional change of the drag input.

Referring to FIG. 8D, if the touch sensing unit is arranged over the entire region of a monitor bezel, the drag input in which the dragging direction is changed according to a directional change in movement on the bezel is performed. Thus, the imaginary division line 820 is changed to the imaginary division line 830 as illustrated in FIG. 8C.

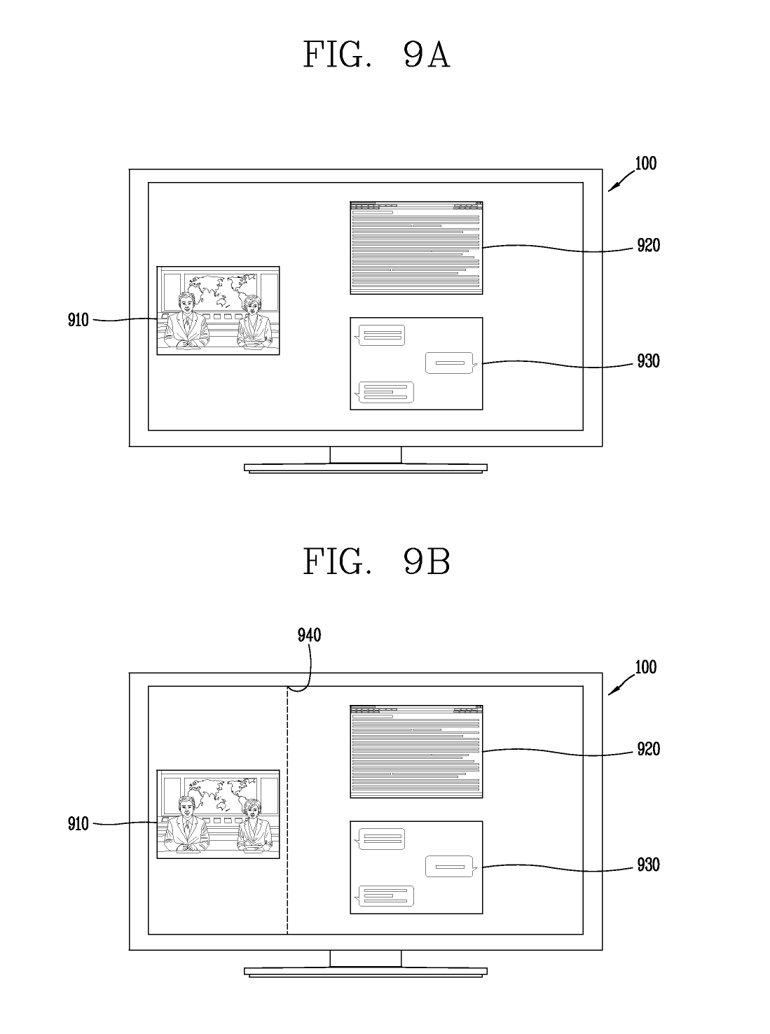

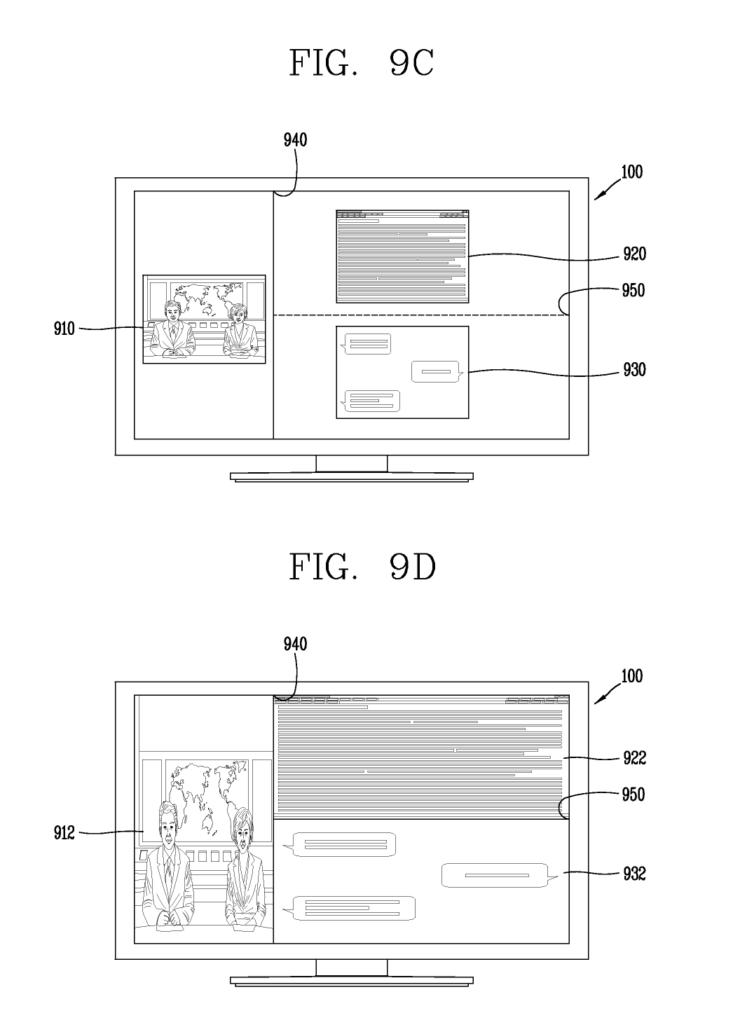

FIGS. 9A to 9D are diagrams, each illustrating an embodiment of a process in which the screen is divided by the image display device 100 according to the present invention.

Referring to FIG. 9A, first, second, and third window regions 910, 920, and 930 are output to the screen 170 before entering the division mode.

Referring to FIG. 9B, when the touch sensing unit senses the long touch input for entering the division mode, a first imaginary line is output to a portion corresponding to a border line between the first window region 910 and the second and third window regions 920 and 930. At this point, as described above, the user adjusts a position of the first imaginary division line that is output, with the drag input.

Referring to FIG. 9C, when the touch sensing unit senses the touch input that confirms the first imaginary division line, such as an input in which after applying the long touch illustrated in FIG. 9B the touch input is stopped, the screen 170 is divided along a first imaginary division line 940.

This divides the screen 170 into two divisional regions. According to the embodiment described above, since the number of the window regions and the number of the divisional regions are not consistent with each other, a second imaginary division line is output to a portion 950 corresponding to a border line between the second window region and the third window region.

Referring to FIG. 9D, as described above, a position of the second imaginary division line is adjusted with the drag input, and the screen 170 is divided, by the touch input confirming the second imaginary division line, into first, second, and third divisional regions 912, 922, and 932.

As described above, the content that is displayed on the window region is output to the divisional region that is located in the position corresponding to the window region.

Specifically, a TV screen being displayed on the first window region 910 is output to the first divisional region 912, a document being created on the second window region 920 is output to the second divisional region 922, and a messenger being executed on the third window region 930 is output to the third divisional region 932.

An order in which the imaginary division lines are output is not limited to the order in which the imaginary division lines are output as illustrated in FIG. 9B and FIG. 9C. That is, after the second imaginary division line is first output to the portion 950 corresponding to the border line between the second window region and the third window region, when the second imaginary division line is confirmed, the first imaginary division line may be output to the portion 940 corresponding to the border line between the first window region 910 and the second and third window regions 920 and 930.

In addition, until after the imaginary division lines are output, the imaginary division lines that are output are all confirmed, that is, in the steps illustrated in FIG. 9B and FIG. 9C, a predetermined waiting screen may be output along with the imaginary division line, or the screen that is present before division may continue to be output.

Alternatively, the content to be output may be displayed in advance with an effect of a dimly-displayed image. For example, TV content is output to the first divisional region 912 that is earlier confirmed as illustrated in FIG. 9C, in a dimly displayed manner.

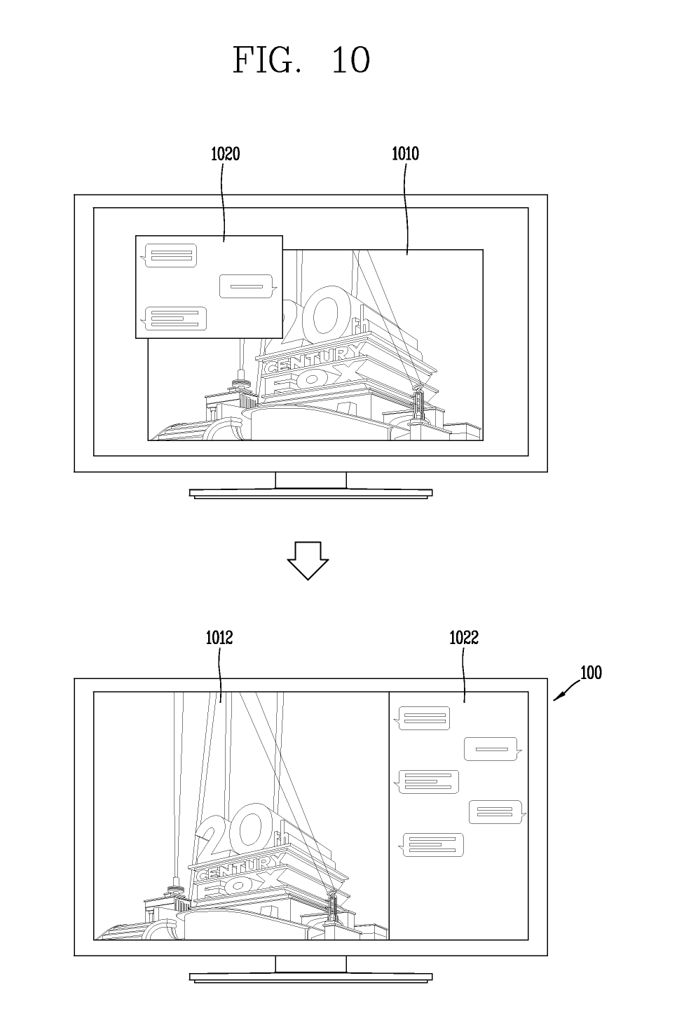

FIG. 10 is a diagram illustrating an embodiment in which the content is output to each of the divisional regions.

Referring to FIG. 10, the items of content displayed output to the multiple divisional regions, respectively, considering types of the items of content displayed on the window regions and areas of the multiple divisional regions.

Specifically, it is seen from FIG. 10 that before entering the division mode, a moving image is displayed on a first window region 1010 and a messenger is executed on a second window region 1020. Accordingly, after completing the division, the moving image is output to a first divisional region 1012 that is broader than a second divisional region 1022, and the messenger is executed on the second divisional region 1022.

That is, the moving image is set in such a manner that the moving image is preferentially arranged in the broader divisional region, because the displaying of the moving image one the comparatively broader region is convenient for the user, compared to the message. This arrangement is according to one embodiment. In order to determine which type of content is output to the broader divisional region, types of content may be prioritized based on various references.

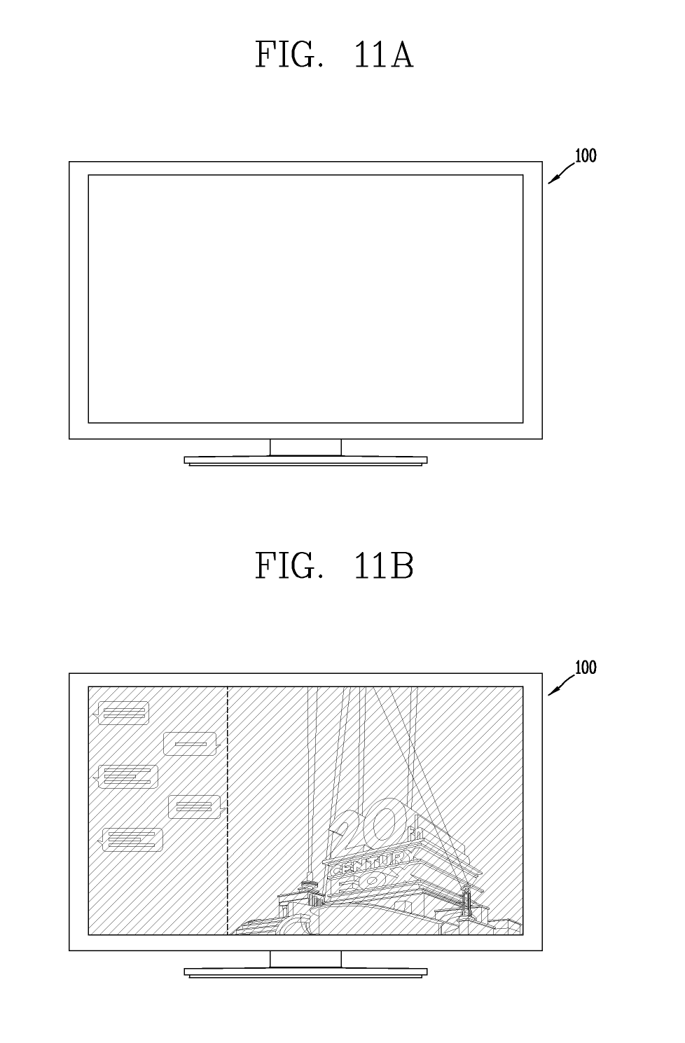

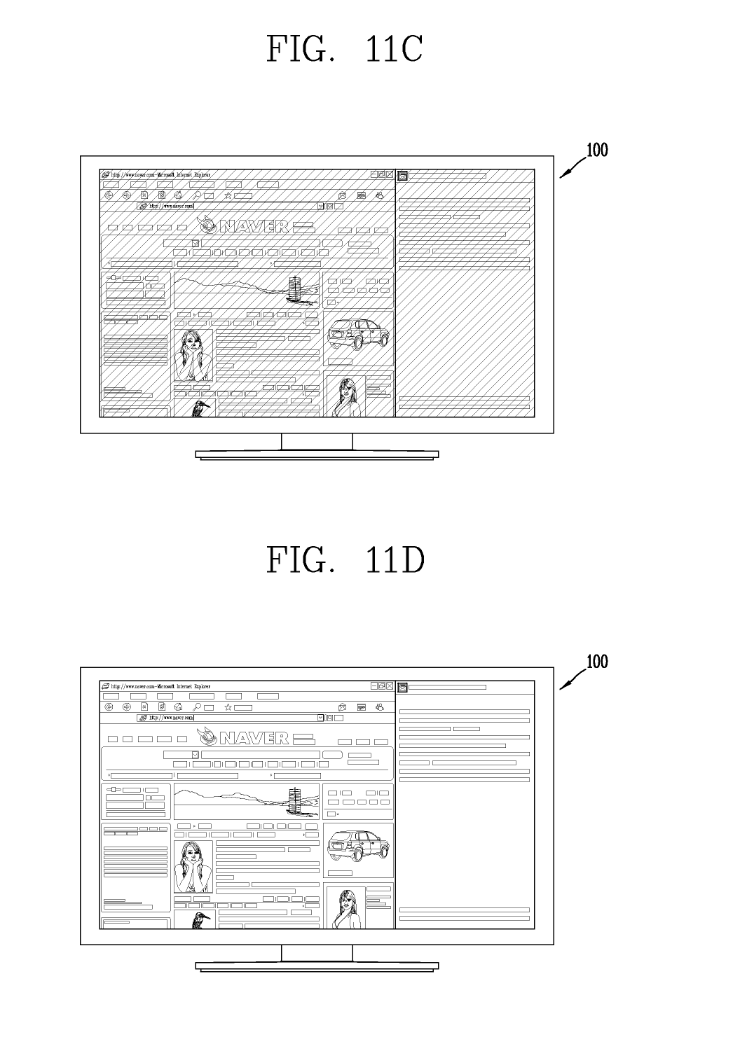

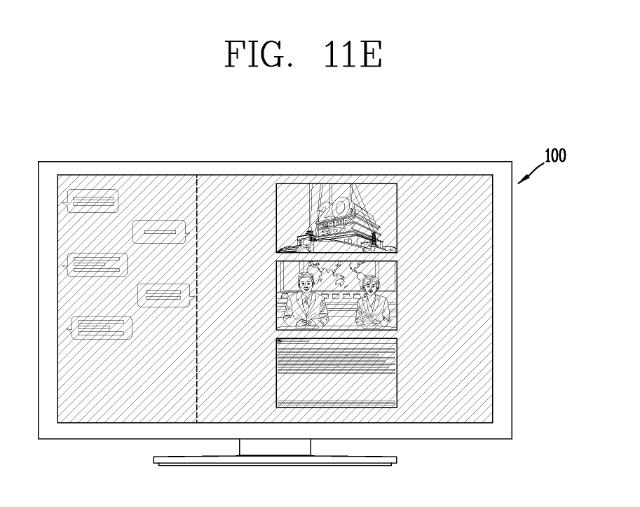

FIGS. 11A to 11E are diagrams illustrating an embodiment of a process in which in a state where the window region is not output, the screen is divided by the image display device the according to the present invention.

It is seen from FIG. 11A that before entering the division mode, the window region is not output. That is, the content displayed is absent, and the waiting screen is output to the screen 170.

Referring to FIG. 11B, when the touch input for entering the division mode is sensed, it is possible to display in advance the items of content that are to be output to the multiple divisional regions that will be generated when the imaginary division line is confirmed, respectively, along with the imaginary division line.

Specifically, the messenger message and the moving image content are output to the divisional regions that result from the division along the imaginary line that is output, respectively, with the effect of the dimly-displayed image.

Referring to FIG. 11C, as the drag input is applied rightward, so the imaginary division is rightward moved. Due to this movement of the imaginary division line, the divisional regions also are also moved and at the same time the content to be output is also changed.

Specifically, according to the drag input, the imaginary division line is rightward moved and at the same time the content is output in such a manner that the messenger message is changed to the web browser content, and the moving image is changed to email content. That is, the user sets the areas of the divisional regions and the content to be output at the same time with the drag input.

Referring to FIG. 11D, when the touch input, as described above, which confirms the imaginary division line, is sensed, the screen 170 is divided into the multiple divisional regions, along the confirmed imaginary division line, and the web browser content and the email content are output to the multiple divisional regions, respectively.

Referring to FIG. 11E, it is possible to display in advance a list of the multiple items of content that are to be output to the divisional regions that will be generated when the imaginary line is confirmed, respectively, along the imaginary line.

Specifically, Internet content, TV broadcast content, and email content that are to be output to the divisional regions are displayed in advance in a small-sized manner, or icons corresponding to them are output. Then, when one item of content is selected from among the items of content that are output and the imaginary division line is confirmed, the selected item of content is output to the generated divisional region.

On the other hand, the touch sensing unit may be realized within the touch screen. In this case, the screen division is made in the same manner as when the touch sensing unit is realized as the separate touch panel 410.

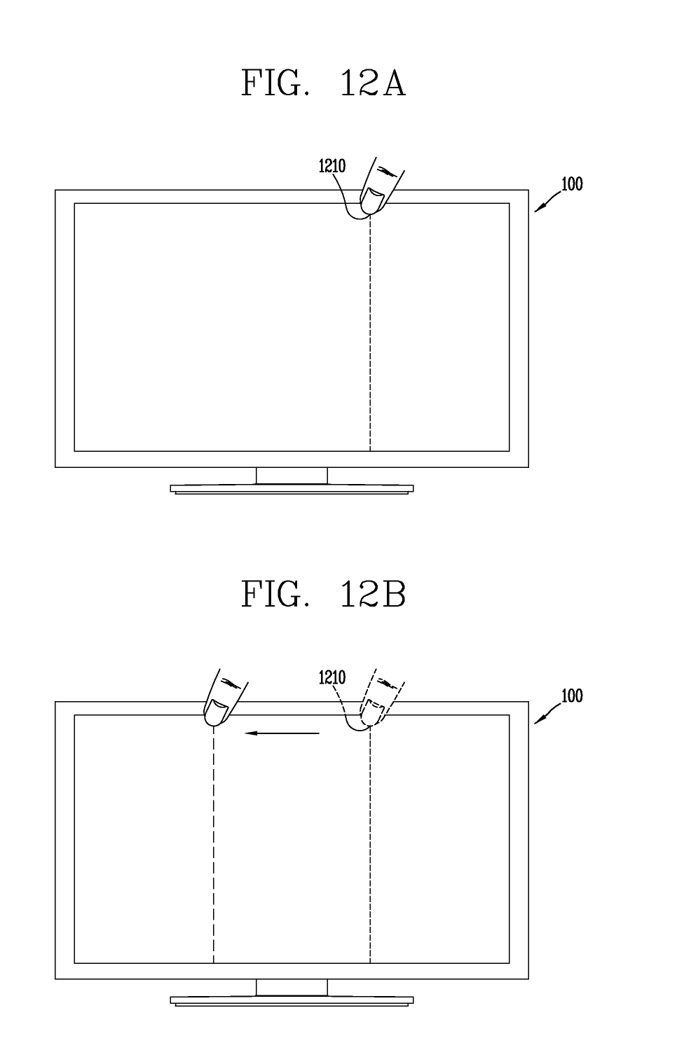

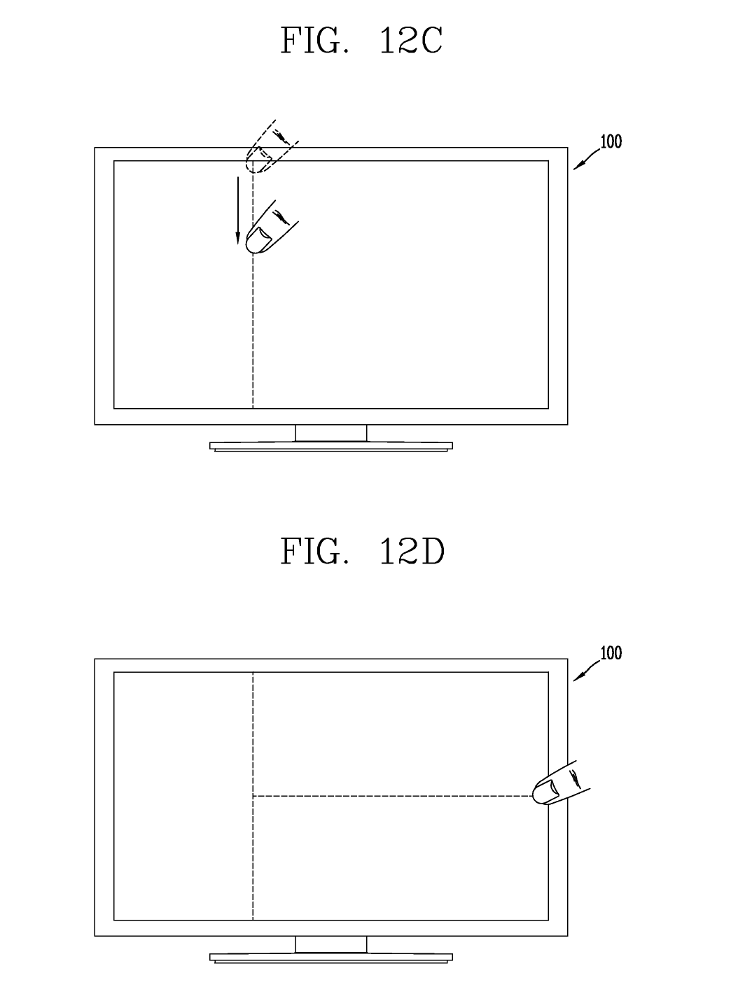

FIGS. 12A to 12D are diagrams illustrating the image display device according to the present invention in a case where the touch sensing unit is realized as the touch screen.

Referring to FIG. 12A, when the long touch is applied to a region within the touch screen 170, adjacent to the edge of the touch screen 170, the division mode is entered and an indicator indicating that the division mode is entered is output to a long touch point 1210. Then, the screen 170 is longitudinally divided along the imaginary division line that is output from the long touch point 1210.

Referring to FIG. 12B, the imaginary division line is moved according to the drag input, and the content that is to be output to the divisional region that will be accordingly generated is output with the effect of the dimly-displayed image.

According to one embodiment, when the items of content that are displayed on the window region are present before entering the division mode, such items of content may be output to the divisional regions, respectively.

According to another embodiment, if no item of content that is displayed on the window region is present before entering the division mode, at least one or more predetermined items of content may be output to the divisional regions, respectively.

The content that is to be output at this point, is set considering a size of the divisional region. For example, when the size of the divisional region falls within a predetermined range, setting is provided in such a manner that specific content is output. This is the same as the manner in which the content is output in a case where the touch sensing unit is realized as the touch panel described above.

In addition, as described above, the setting may be provided in such a manner that the list of the multiple items of content from which to choose is output.

Referring to FIG. 12C, the screen 170 is divided according to the drag input applied to the touch screen 170 (along the imaginary division line). At this point, the content that is earlier selected or the content that is preparatorily output in advance along with the imaginary division line is arranged in each of the divisional regions.

Referring to FIG. 12D, the imaginary division line is additionally output according to the number of the window regions that are displayed after generating the first and second divisional regions but before entering the division mode. At this point, the position to which the imaginary division line is output is set in the same manner as when the touch sensing unit is realized as the touch panel described above.

Alternatively, if the screen 170 is additionally divided, the screen 170 is divided by again applying the long touch to the region within the screen 170 adjacent to the edge in the same manner as described above.

The various embodiments are described above in order to describe original technological ideas associated with various aspects of the present invention. However, distinctive characteristics of one embodiment can be applied to any of the different embodiments. Some of the constituent elements or the steps according to each of the embodiments, described referring to the drawings, can be modified or adjusted. The constituent elements and the steps can be deleted or moved, and additional constituents and steps can be included in each of the embodiments.

The various distinctive characteristics and technological idea, described above, can be realized as being in the form of software, hardware, firmware, middleware or a combination of them. For example, a program for realizing a method of receiving a three-dimensional signal in digital broadcast and a device for receiving the three-dimensional signal, which is stored in a computer-readable medium (which is executed by a computer or a controller including a CPU), includes one or more program codes and sections that perform various tasks. For example, a program for realizing a method of receiving a three-dimensional signal in digital broadcast and a device for receiving the three-dimensional signal, which is stored in a computer-readable medium (which is executed by a computer or a controller including a CPU), includes one or more program codes and sections that perform various tasks.

According to the present invention, the screen can be divided considering the screen position and type of the content that is displayed before dividing the screen and the number of the items of content, based on a predetermined reference. Accordingly, the user interface before or after the screen division can be maintained in the similar manner. As a result, the convenience of the user can be improved.

The configuration and the method of the embodiments according to the present invention, described above, are not applied in a limiting manner, but all of or some of the embodiments may be selectively combined with each other to create various modifications to the embodiments.

It will also be apparent to those skilled in the art that various modifications and variations can be made in the present invention without departing from the spirit or scope of the invention. Thus, it is intended that the present invention cover modifications and variations of this invention provided they come within the scope of the appended claims and their equivalents.

1. An image display device, comprising:
a touch sensing unit that senses a touch input;
a display unit to which a window on which content is displayed is output; and
a controller that, when the touch sensing unit senses the touch input for entering a division mode, outputs at least one or more imaginary division lines along which the display unit is divided, to a position that is according to a predetermined reference, considering the number of window regions that are output to the display unit before entering the division mode, and when the touch input that confirms the imaginary division line is sensed, divides the display unit into multiple divisional regions along the imaginary division line and outputs the items of content displayed on the window regions to the multiple divisional regions, respectively, according to a predetermined reference.

2. The image display device of claim 1, wherein the touch sensing unit is realized as a touch panel arranged adjacent to the display unit or is realized within an input device that can remotely communicate with the display unit.

3. The image display device of claim 1, wherein the controller moves the imaginary division line according to the drag input sensed by the touch sensing unit.

4. The image display device of claim 1, wherein the controller outputs the imaginary division line along which the display unit is divided into the divisional regions, each of which is located in a position corresponding to a position on the display unit, to which the window region is output.

5. The image display device of claim 1, wherein the controller outputs the items of content that are displayed, to the multiple divisional regions, respectively, considering types of the items content that are displayed on the window regions and areas of the multiple divisional regions.

6. The image display device of claim 1, wherein the controller outputs the item of content that are displayed on the window regions, to the divisional regions, each of which is located in a position corresponding to a position on the display unit, to which the window region is output, respectively.

7. The image display device of claim 1, wherein when the touch sensing unit senses the touch input for entering the division mode in a state where the window region to be output to the display unit is absent, the controller displays in advance the items of content that are to be output to the divisional regions that will be generated according to whether to confirm the imaginary division line, along with the imaginary division line along which the display unit is divided.

8. The image display device of claim 7, wherein the controller moves the imaginary division line according to the sensed drag input, and displays in advance the items of content that are to be output to the divisional regions that will be generated according to whether to confirm the moved imaginary division line.

9. The image display device of claim 7, wherein the controller divides the display unit into the multiple divisional regions along the imaginary division line when the touch input that confirms the imaginary division line is sensed, and
wherein the controller outputs the items of content that are displayed in advance, to the multiple divisional regions, respectively.

10. A method of controlling an image display device, comprising:
a step (a) of enabling a touch sensing unit to sense a touch input for entering a division mode;
a step (b) of outputting an imaginary division line along which the display unit is divided, to a position that is according to a predetermined reference;
a step (c) of dividing the display unit into multiple divisional regions along the imaginary division line when the touch sensing unit senses a touch input that confirms the imaginary division line;
a step (d) of repeating the step (b) and the step (c) considering the number of window regions on which items of content are displayed before entering the division mode; and
a step (e) of outputting the items of content that are displayed on the window regions to the multiple division regions, respectively, when the imaginary division lines that are output are all confirmed.

11. The method of claim 10, wherein the touch sensing unit is realized as a touch panel arranged adjacent to the display unit or is realized within an input device that can remotely communicate with the display unit.

12. The method of claim 10, wherein the step (b) includes a step of moving the imaginary division line according to the drag input sensed by the touch sensing unit.

13. The method of claim 10, wherein the step (b) includes a step of outputting the imaginary division line along which the display unit is divided into the divisional regions, each of which is located in a position corresponding to a position on the display unit, to which the window region is output.

14. The method of claim 10, wherein the step (e) includes a step of outputting the items of content that are displayed, to the multiple divisional regions, respectively, considering types of the items of content that are displayed on the windows region and areas of the multiple divisional regions.

15. The method of claim 10, wherein the step (e) includes a step of outputting the items of content that are displayed on the window regions to the divisional regions, each of which is located in a position corresponding to a position on the display unit, to which the window region is output.

16. The method of claim 10, wherein when the touch sensing unit senses the touch input for entering the division mode in a state where the window region to be output to the display unit is absent, the step (b) includes a step of displaying in advance the items of content that are to be output to the divisional regions that will be generated according to whether to confirm the imaginary division line, along with the imaginary division line along which the display unit is divided.

17. The method of claim 16, wherein the step (b) includes a step of moving the imaginary division line according to the sensed drag input, and displaying in advance the items of content that are to be output to the divisional regions that will be generated according to whether to confirm the moved imaginary division line.

18. The method of claim 16, wherein the step (c) includes a step of dividing the display unit into the multiple divisional regions along the imaginary division line when the touch input that confirms the imaginary division line is sensed, and
wherein the step (e) includes a step of outputting the items of content that are displayed in advance, to the multiple divisional regions, respectively.
